(19) United States
(12) Patent Application Publication
(10) Pub. No.: US 2013/0050598 A1
(43) Pub. Date: Feb. 28, 2013

(54) DRIVE METHOD OF DISPLAY ELEMENT INCLUDING CHOLESTERIC LIQUID CRYSTAL AND CHOLESTERIC LIQUID CRYSTAL DISPLAY DEVICE

(71) Applicant: Hirokata UEHARA, Kawasaki (JP)

(72) Inventor: Hirokata UEHARA, Kawasaki (JP)

(73) Assignee: FUJITSU LIMITED, Kawasaki-shi (JP)

(21) Appl. No.: 13/534,177

(22) Filed: Jun. 27, 2012

(30) Foreign Application Priority Data
Aug. 26, 2011 (JP) 2011-184811

(51) Int. Cl. G02F 1/133

(52) U.S. Cl. 349/33

(57) ABSTRACT

A cholesteric liquid crystal display device includes: a cholesteric liquid crystal display element; a segment driver and a common driver; a multi-voltage generation circuit configured to generate voltages supplied to the segment driver and the common driver; a temperature sensor; and a control circuit configured to control the segment driver, the common driver, and the multi-voltage generation circuit, wherein the control circuit: controls the segment driver and the common driver to perform a dynamic drive sequence having a preparation period during which the cholesteric liquid crystal is brought into a homeotropic state, a selection period during which the final state of the cholesteric liquid crystal is selected, and an evolution period during which the cholesteric liquid crystal is made to transition to the state selected during the selection period; and controls the applied voltage to the cholesteric liquid crystal during the evolution period to change in accordance with temperature.

### CROSS-REFERENCE TO RELATED APPLICATION

This application is based upon and claims the benefit of priority of the prior Japanese Patent Application No. 2011-184811, filed on Aug. 26, 2011, the entire contents of which are incorporated herein by reference.

### FIELD

The embodiments discussed herein are related to a drive method of a display element including cholesteric liquid crystal and a cholesteric liquid crystal display device.

### BACKGROUND

As a display device, for example, a display device using liquid crystal, such as electronic paper, is being developed. For example, a display element using cholesteric liquid crystal takes a planar state where light of a specific wavelength is reflected, a focal conic state where light is transmitted, and an intermediate state between the planar state and the focal conic state by adjusting the intensity of an electric field to be applied and an image is displayed by setting liquid crystal of each pixel to any of the states.

As a drive method of a display device using liquid crystal, for example, the dynamic drive system (DDS) is used. By using the DDS, it is possible to rewrite a high contrast image at a high speed.

The drive period by the DDS is roughly divided into three stages and includes, from the front, a “reset (preparation)” period, a “switching (selection)” period, and a “maintenance (evolution)” period. Before and after the preparation period, the selection period, and the evolution period, non-select periods are provided. The reset period is also referred to as a preparation period, the switching period a selection period, and the maintenance period an evolution period in some cases.

The preparation period is a period during which liquid crystal is initialized into the homeotropic state. During the preparation period, a plurality of reset (preparation) pulses having a relatively high voltage is applied.

The selection period is a period during which branching of the final state into the planar state (bright state: white display) or the focal conic state (dark state: black display) is triggered. During the selection period, the homeotropic state is almost formed when the state is switched to the planar state finally or a transient planar state is almost formed when switched to the focal conic state. During the selection period, a selection pulse having a relatively high voltage is applied when the state is switched to the planar state or a selection pulse having a relatively low voltage is applied when switched to the focal conic state.

During the evolution period, in response to the change to the transient state during the immediately previous selection period, the planar state or the focal conic state is settled. During the evolution state, a plurality of maintenance (evolution) pulses having a voltage between that of the preparation pulse and that of the selection pulse is applied.

The drive voltage of liquid crystal has temperature dependence and this is the same as in the case of cholesteric liquid crystal, and therefore, it is desirable to perform temperature compensation of the drive voltage of the cholesteric liquid crystal by the dynamic drive system.

### RELATED DOCUMENTS

### [Patent Document 1] Japanese Laid Open Patent Document No. 2003-140114

### [Patent Document 2] Japanese Laid Open Patent Document No. 2007-128043

[Patent Document 3] U.S. Pat. No. 5,748,277
[Non-Patent Document 1] J. Ruth, et.al. “LOW COST DYNAMIC DRIVE SCHEME FOR REFLECTIVE BISTABLE CHOLESTERIC LIQUID CRYSTAL DISPLAYS”, Flat Panel Display '97.

### [Non-Patent Document 1] J. Gandhi and D. K. Yang “Temperature Compensation of the Dynamic Drive Scheme for Bistable Cholesteric Displays”, SID Symposium Digest of Technical Papers, May 1998, Volume 29, Issue 1, pp. 794-797

### SUMMARY

According to a first aspect of the embodiment, a method of a display element including cholesteric liquid crystal is provided. The method includes: a preparation period during which the cholesteric liquid crystal is brought into a homeotropic state; a selection period during which a final state of the cholesteric liquid crystal is selected; and an evolution period during which the cholesteric liquid crystal is made a transition to a state selected during the selection period. A voltage applied to the cholesteric liquid crystal during the evolution period is changed in accordance with temperature.

According to a second aspect of the embodiment, a cholesteric liquid crystal display device includes: a cholesteric liquid crystal display element; a segment driver and a common driver that apply voltages to the cholesteric liquid crystal; a multi-voltage generation circuit configured to generate and supply a plurality of power source voltages to the segment driver and the common driver; a temperature sensor; and a control circuit configured to control the segment driver, the common driver, and the multi-voltage generation circuit. The control circuit controls the segment driver and the common driver to perform a dynamic drive sequence having a preparation period during which the cholesteric liquid crystal is brought into a homeotropic state, a selection period during which the final state of the cholesteric liquid crystal is selected, and an evolution period during which the cholesteric liquid crystal is made a transition to the state selected during the selection period. Further, the control circuit controls the applied voltage to the cholesteric liquid crystal during the evolution period to change in accordance with temperature.

The object and advantages of the embodiments will be realized and attained by means of the elements and combination particularly pointed out in the claims.

It is to be understood that both the foregoing general description and the following detailed description are exemplary and explanatory and are not restrictive of the invention.

### BRIEF DESCRIPTION OF THE DRAWINGS

FIG. 1A is a diagram illustrating a pulse of 60 ms applied to cholesteric liquid crystal;

FIG. 1B is a diagram illustrating a voltage response characteristics of the cholesteric liquid crystal when the pulse of 60 ms is applied;

FIG. 1C is a diagram illustrating a pulse of 10 ms applied to cholesteric liquid crystal;

FIG. 1D is a diagram illustrating a voltage response characteristics of the cholesteric liquid crystal when the pulse of 10 ms is applied;

FIG. 2A is a diagram illustrating the state transition in a conventional drive system;

FIG. 2B is a diagram illustrating the state transition in a dynamic drive system;

FIG. 3A is a diagram illustrating a waveform to be applied in the dynamic drive system when a pixel is made black;

FIG. 3B is a diagram illustrating a waveform to be applied in the dynamic drive system when a pixel is made white;

FIG. 4A to FIG. 4C are diagrams explaining the scan operation in the dynamic drive system;

FIG. 5A is a diagram illustrating a pattern on a display in a way “F” is written;

FIG. 5B is a diagram illustrating distribution of voltage waveforms applied to each pixel in the state of FIG. 5A;

FIG. 6 is a diagram illustrating a voltage waveform in details applied to liquid crystal molecules in the dynamic drive system;

FIG. 7 is a block diagram illustrating a configuration of a cholesteric liquid crystal display device of the embodiment;

FIG. 8 is a diagram illustrating a configuration of the display element used in the embodiment;

FIG. 9 is a diagram illustrating a configuration of one panel;

FIG. 10A is a diagram illustrating a configuration of a segment driver;

FIG. 10B is a diagram illustrating a configuration of a common driver;

FIG. 11 is a diagram illustrating an example of a power source voltage to be applied to a segment driver (SEG) and a common driver (COM) in a cholesteric liquid crystal display device using a simple matrix system;

FIG. 12 is a diagram illustrating voltage waveforms the segment driver (SEG) outputs during the preparation, selection, evolution, and non-select periods, voltage waveforms the common driver (COM) outputs in accordance with the white and black displays, and voltage waveforms applied to the liquid crystal;

FIG. 13A and FIG. 13B are diagrams illustrating the temperature dependence of the drive voltage during the evolution period;

FIG. 14 is a diagram illustrating voltages to be supplied to the common driver and the segment driver to set the drive voltage during the evolution period to 18 V;

FIG. 15 is a diagram illustrating examples of voltage waveforms the segment driver (SEG) and the common driver (COM) output and voltage waveforms applied to the liquid crystal when voltages in FIG. 14 are supplied;

FIG. 16 is a diagram illustrating examples of voltages to be supplied to the common driver and the segment driver when the temperature is low;

FIG. 17 is a diagram illustrating voltage waveforms the segment driver (SEG) and the common driver (COM) output and voltage waveforms to be applied to the liquid crystal when the temperature is low;

FIG. 18 is a diagram illustrating the reflectance characteristics at a low temperature of 10° C. of the cholesteric liquid crystal display device of the embodiment;

FIG. 19 is a diagram illustrating the internal configuration of the driver control circuit and related parts;

FIG. 20A and FIG. 20B are diagrams illustrating examples of a voltage generation circuit in the multi-voltage generation unit;

FIG. 21A is a diagram illustrating a COM voltage LUT for a first condition;

FIG. 21B is a diagram illustrating a COM voltage LUT for a second condition;

FIG. 21C is a diagram illustrating a SEG voltage LUT;

FIG. 22A is a graph illustrating the change in the optimum evolution voltage to a change in temperature;

FIG. 22B is a diagram illustrating a table storing the optimum evolution voltage and the non-select voltage at each temperature;

FIG. 23 is a diagram illustrating a processing flow of the above-mentioned processing.

### DESCRIPTION OF EMBODIMENTS

Hereinafter, embodiments are explained with reference to figures, the technical scope of the present invention is not limited to these embodiments but includes items described in the scope of claims and further equivalents thereof.

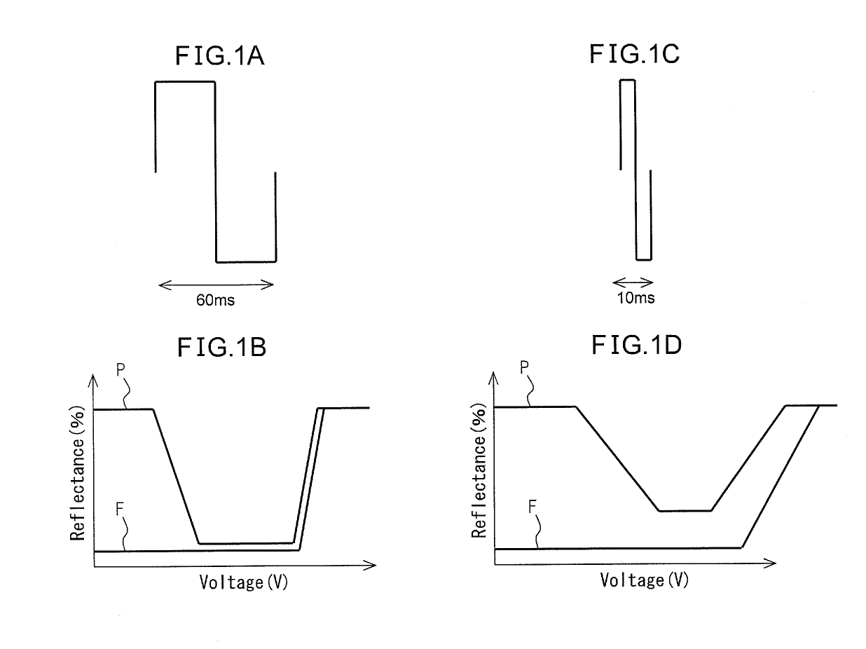

FIGS. 1A to 1D are diagrams illustrating the voltage response characteristics of cholesteric liquid crystal. FIG. 1A illustrates a pulse of 60 ms applied to cholesteric liquid crystal. FIG. 1B illustrates the voltage response characteristics of cholesteric liquid crystal when a pulse of 60 ms is applied. FIG. 1C illustrates a pulse of 10 ms applied to cholesteric liquid crystal. FIG. 1D illustrates the voltage response characteristics of cholesteric liquid crystal when a pulse of 10 ms is applied. In general, as a voltage applied to liquid crystal (applied voltage to liquid crystal), a pair of positive and negative pulses is applied in order to prevent polarization of liquid crystal. In the following explanation, a pair of positive and negative pulses is together referred to as a pulse in some cases and the period of the sum of those pair of positive and negative pulses is referred to as a pulse width in some cases.

As illustrated in FIGS. 1A to 1D, in the case where the initial state is the planar state, when the pulse voltage is raised to a certain range, the drive band to the focal conic state is entered and when the pulse voltage is further raised, the drive band to the planar state again is entered as illustrated by a line P. In the case where the initial state is the focal conic state, as the pulse voltage is raised, the drive band to the planar state is entered gradually as illustrated by a line F.

When a pulse with a short pulse width is applied, the energy given is small, and therefore, the amount of change is small compared to the case where a pulse with a great pulse width is applied and the voltage characteristics shift toward the side of higher voltages.

The drive method of a cholesteric liquid crystal display device is roughly divided into the conventional drive system and the dynamic drive system.

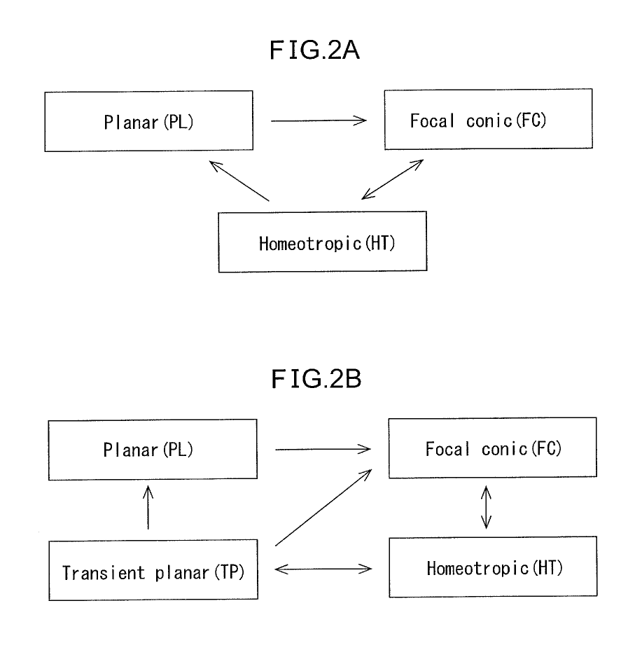

FIG. 2A and FIG. 2B are diagrams for explaining the state transition in the conventional drive system and the dynamic drive system. FIG. 2A illustrates the state transition in the conventional drive system and FIG. 2B illustrates the state transition in the dynamic drive system.

As illustrated in FIG. 2A, the conventional drive system controls the transition between the three states described above, that is, the planar state (PL), the focal conic state (FC), and the homeotropic state (HT) by the pulse wave height and the pulse width in accordance with the characteristics of FIG. 1. The transition to the focal conic state takes a long time, and therefore, an increase in the speed when producing a display is a general problem.

As illustrated in FIG. 2B, the dynamic drive system uses a transient planar state (TP) in addition to the three states described above. In the transient planar state, the helical axis of liquid crystal is oriented in a direction perpendicular to the substrate (electrode) as in the planar state, however, the pitch of the helical axis is about twice that in the planar state. When an electric field with a predetermined intensity is applied, the transient planar state changes to the focal conic state.

The dynamic drive system is a system that uses the oblique line parts on the right side of the voltage response characteristics in FIG. 1A and FIG. 1B and sets for each line whether the final state is the planar state or the focal conic state, and proceeds to the processing of the next line without waiting until the state of the line is settled. The time to set each line is about 1 ms and the setting is performed in a pipeline manner, and therefore, when the number of lines of the display panel is assumed to be 1,000, it is possible to rewrite the display in about one second.

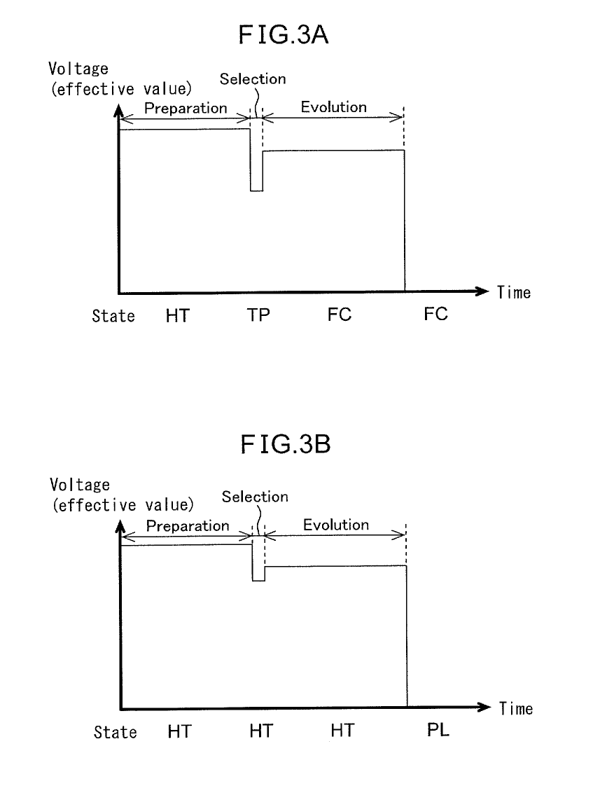

FIG. 3A and FIG. 3B are diagrams illustrating waveforms to be applied (applied waveforms) in the dynamic drive system. FIG. 3A illustrates a waveform when a pixel is made black and FIG. 3B illustrates a waveform when a pixel is made white.

As illustrated in FIG. 3A and FIG. 3B, the applied waveform in the dynamic drive system includes the “reset (preparation)” period, the “switching (selection)” period, and the “maintenance (evolution)” period.

During the preparation period, a voltage that brings liquid crystal into the homeotropic state is applied. After that, by supplying a low voltage pulse during the selection period, which is a brief time, whether the homeotropic state is maintained or the state is relaxed to the transient planar state is set. During the evolution period after that, a voltage suitable for the transition from the planar state to the focal conic state is applied. A pixel in the homeotropic state maintains this state during the evolution period and makes a transition to the planar state when the evolution period ends. A pixel in the transient planar state makes a transition to the focal conic state during the evolution period. During the selection period, only the transition to one of the planar state and the focal conic state is set, and therefore, it is possible to perform the setting in a brief time. Because of this, it is possible to produce a display at a high speed.

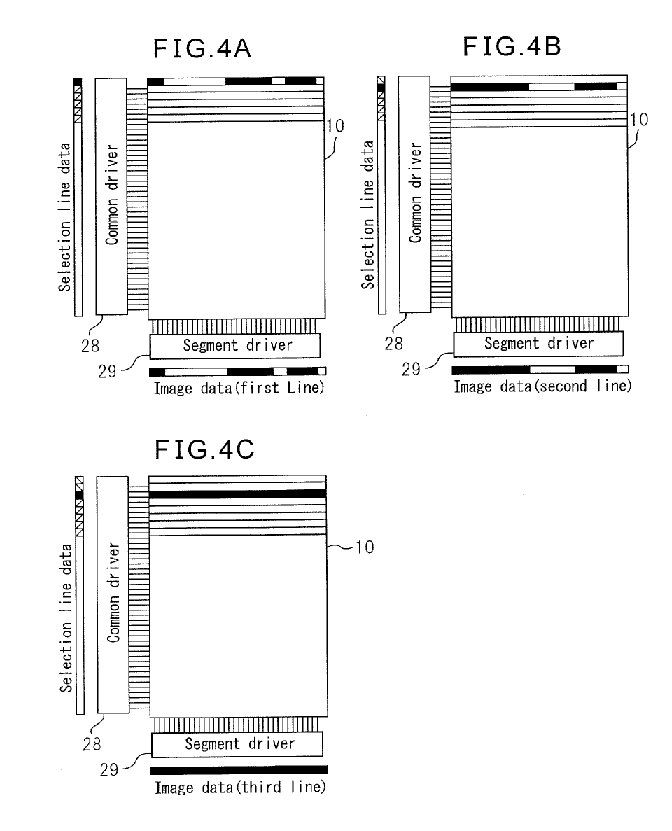

FIG. 4A to FIG. 4C are diagrams for explaining the scan operation in the dynamic drive system. The drive method of a flat panel display, such as a liquid crystal display device, includes the simple matrix system and the TFT system. Generally, the cholesteric liquid crystal display device uses the simple matrix system from the viewpoint of the manufacturing cost, etc. In the display device using the simple matrix system, a scan electrode is driven by a common driver 28 and a data electrode is driven by a segment driver 29.

FIG. 4A to FIG. 4C illustrate an example in which before and after the selection period, the preparation period and the evolution period the length of which is five times that of the selection period are provided. FIG. 4A illustrates a case where the zeroth line is the selection period. In this case, the first line to the fifth line are the preparation period and lines other than the zeroth line to the fifth line are the non-select period. FIG. 4B illustrates a case where the first line is the selection period. In this case, the second line to the sixth line are the preparation period, the zeroth line is the evolution period, and lines other than the zeroth line to the sixth line are the non-select period. FIG. 4C illustrates a case where the second line is the selection period. In this case, the third line to the seventh line are the preparation period, the zeroth to first lines are the evolution period, and lines other than the zeroth line to the seventh line are the non-select period. After this, write is performed while shifting the line during the selection period.

The preparation period and the evolution period before and after the selection period are in the state of black display and it seems that a black band shifts. In the example described above, the preparation period and the evolution period are illustrated as to have a length five times that of the selection period, however, actually, about tens of times to hundred of times, and therefore, it seems that a thick black band shifts during the period of rewrite.

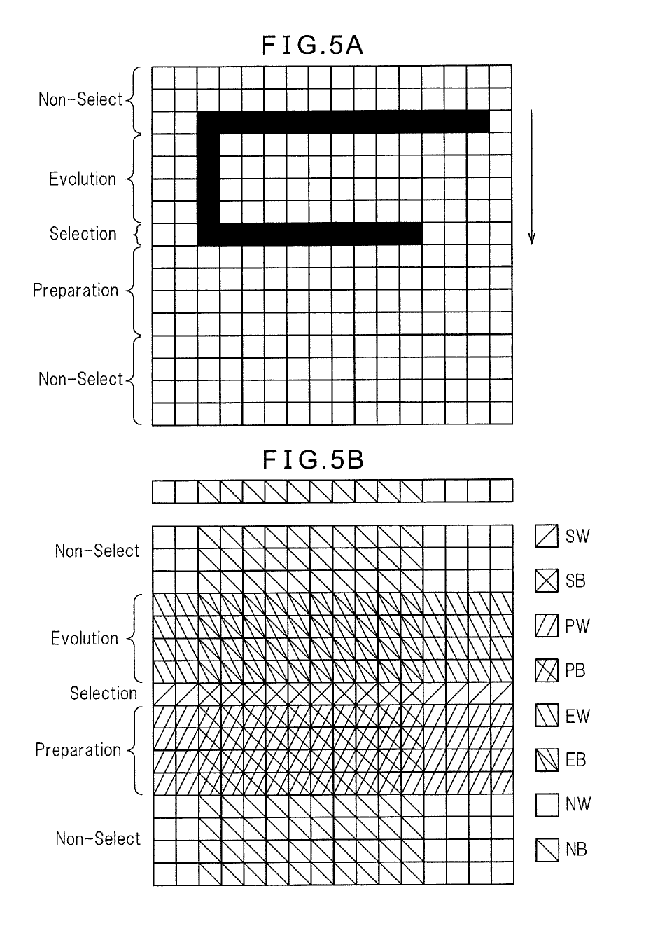

FIG. 5A is a diagram illustrating a pattern on a display in a way “F” is written. As illustrated in FIG. 5A, in the state where the line during the selection period advances to the part of “F”, the four lines during the preparation period and the four lines during the evolution period exist before and after the selection period and other lines are the non-select period. At this time, the segment driver 29 outputs a voltage signal corresponding to the image (black and white) data during the selection period.

FIG. 5B is a diagram illustrating distribution of voltage waveforms applied to each pixel in the state of FIG. 5A. The applied waveforms of a pixel include eight kinds, that is, four kinds of outputs of the common driver 28 during the non-select period, the selection period, the evolution period, and the preparation period and two kinds of outputs of the segment driver 29 of the white display and the black display. The eight kinds of waveforms are represented by NW (non-select and white), NB (non-select and black), SW (selection and white), SB (selection and black), EW (evolution and white), EB (evolution and black), PW (preparation and white), and PB (preparation and black). There exists a pixel to which the eight kinds of voltage waveforms NW, NB, SW, SB, EW, EB, PW, and PB are applied as illustrated in FIG. 5B.

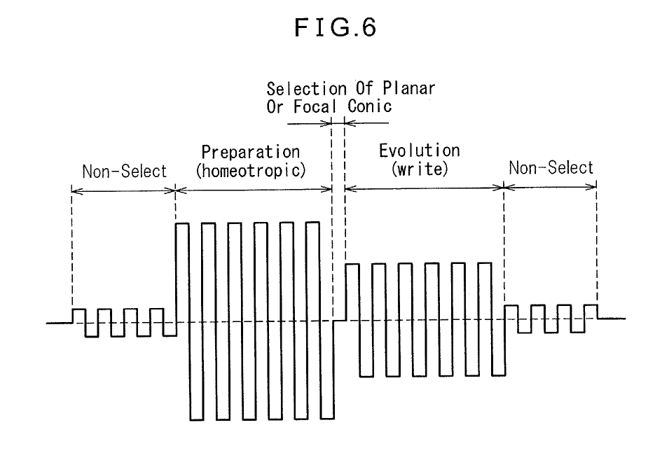

FIG. 6 is a diagram illustrating a voltage waveform applied to liquid crystal molecules more specifically. This voltage waveform is applied to each pixel of one scan line and the waveform during the selection period differs in accordance with pixel data. In the liquid crystal display device, generally, a pair of positive and negative pulses is applied to prevent polarization of liquid crystal and FIG. 6 also illustrates positive and negative pulses as an example.

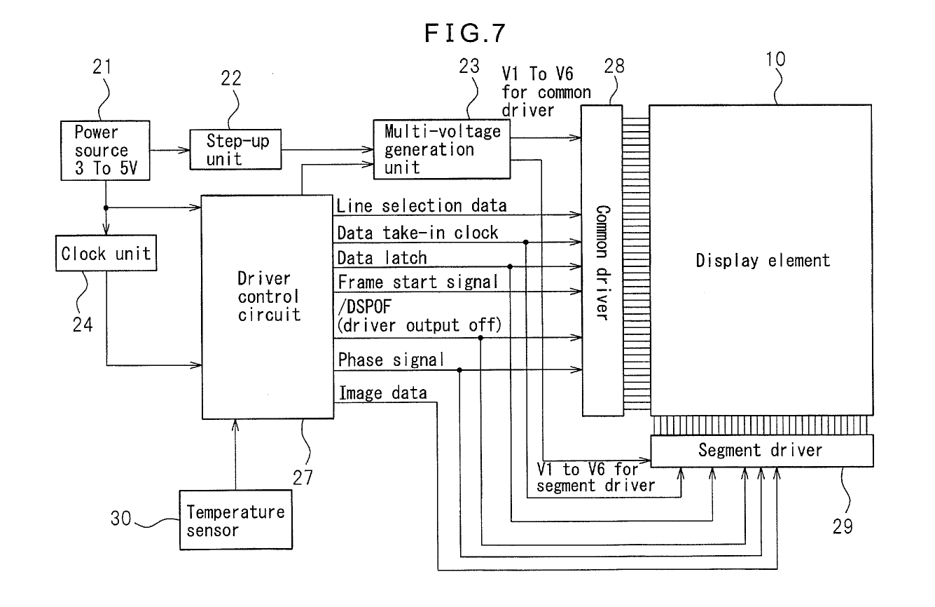

FIG. 7 is a block diagram illustrating a configuration of a cholesteric liquid crystal display device of the embodiment.

The drive method of a flat panel display, such as a liquid crystal display device, includes, for example, the simple matrix system and the TFT system. In general, the cholesteric liquid crystal display device uses the simple matrix system from the viewpoint of manufacturing cost, etc. and the cholesteric liquid crystal display device of the embodiment also uses the simple matrix system.

The cholesteric liquid crystal display device of the embodiment includes a display element 10, a power source 21, a step-up unit 22, a multi-voltage generation unit 23, a clock unit 24, a driver control circuit 27, the common driver 28, the segment driver 29, and a temperature sensor 30. The temperature sensor is provided in close proximity to the display element 10.

The power source 21 outputs a voltage of, for example, 3 V to 5 V. The step-up unit 22 steps up an input voltage from the power source 21 to +36 V to +40 V by a regulator, such as a DC-DC converter. The multi-voltage generation unit 23 generates various kinds of voltages to be supplied to the common driver 28 and the segment driver 29 from the stepped-up power source. The multi-voltage generation unit 23 changes voltages to be generated in accordance with the control signal from the driver control circuit 27.

The clock unit 24 generates a base clock that serves as the base of the operation and generates various kinds of clocks for the operation from the generated base clock.

The display element 10 is a display element producing a color display, in which, for example, three cholesteric liquid crystal panels of RGB are stacked. The specifications of the display element 10 are, for example, the A4-size XGA and 1,024×768 pixels are included. Here, 1,024 scan electrodes and 768 data electrodes are provided and the common driver 28 drives the 1,024 scan electrodes and the segment driver 29 drives the 768 data electrodes. The image data given to each pixel of RGB differs, and therefore, the segment driver 29 drives each data electrode independently. The common driver 28 drives the scan electrodes of RGB in common. The scan line corresponding to the scan electrode at the uppermost part of the screen is taken to be the zeroth line and the scan line corresponding to the scan electrode at the lowermost part of the screen is taken to be the 1,023rd line.

The control circuit 27 generates a control signal based on the base clock, the various kinds of clocks, and image data D and supplies the control signal to the common driver 28 and the segment driver 29. The line selection data is data to specify the scan line during the preparation period, the selection period, and the evolution period to the common driver 28 and here, two-bit data. The image data is data to specify a halftone display of each pixel and the segment driver 29 outputs a signal to be applied to each data electrode based on the image data. A data take-in clock is an image data transfer clock and the segment driver 29 transfers the image data internally in synchronization with the image data transfer clock. A frame start signal is a signal to instruct to start data transfer of a display screen to be rewritten and the common driver 28 resets the inside in response to the frame start signal. A data latch signal is a signal to instruct to end the transfer of the image data of the segment driver 29 and the segment driver 29 latches the image data transferred in response to the signal. Further, the common driver 28 latches the line selection data in response to the data latch signal and at the same times, shifts one line. A driver output off signal/DSPOF is a forced off signal of the applied voltage. A phase signal is a signal, the phase of which is one of four equal periods into which the selection period is divided, and the segment driver 29 controls whether or not to output (whether to turn on or off) a selection pulse in each phase in accordance with the image data and the common driver 28 repeats the same output four times in response to the phase signal.

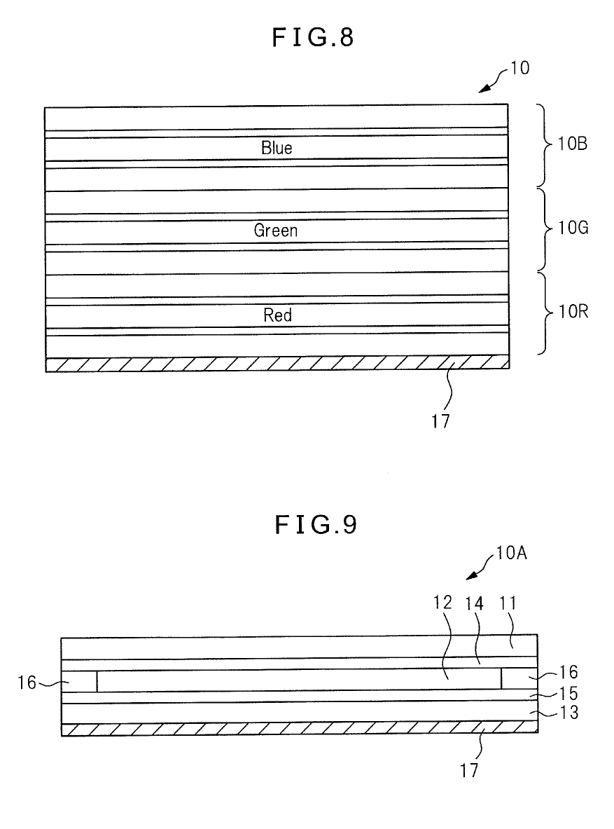

FIG. 8 is a diagram illustrating a configuration of the display element 10 used in the embodiment. As illustrated in FIG. 8, in the display element 10, three panels are stacked in order of a blue panel 10B, a green panel 10G, and a red panel 10R from the viewing side and under the red panel 10R, a light absorbing layer 17 is provided. The panels 10B, 10G, and 10R have substantially the same configuration, however, the liquid crystal materials and the chiral materials are selected and the content percentage of the chiral material is determined so that the center wavelength of reflection of the panel 10B is blue (about 480 nm), the center wavelength of reflection of the panel 10G is green (about 550 nm), and the center wavelength of reflection of the panel 10R is red (about 630 nm). The scan electrode and the data electrode of the panels 10B, 10G, and 10R are driven by the common driver 28 and the segment driver 29.

The panels 10B, 10G, and 10R have substantially the same configuration, except in that the center wavelengths of reflection are different. Hereinafter, a typical example of the panels 10B, 10G, and 10R is represented by a panel 10A and its configuration is explained.

FIG. 9 is a diagram illustrating a configuration of one panel 10A.

As illustrated in FIG. 9, the panel 10A includes an upper side substrate 11, an upper side electrode layer 14 provided on the surface of the upper side substrate 11, a lower side electrode layer 15 provided on the surface of a lower side substrate 13, and a sealing material 16. The upper side substrate 11 and the lower side substrate 13 are arranged so that the electrodes are in opposition to each other and after a liquid crystal material is sealed in between, they are sealed with the sealing material 16. A spacer is arranged within a liquid crystal layer 12, however, not illustrated schematically. To the electrodes of the upper side electrode layer 14 and the lower side electrode layer 15, a voltage pulse signal is applied, and thereby, a voltage is applied to the liquid crystal layer 12. By applying a voltage to the liquid crystal layer 12, the liquid crystal molecules of the liquid crystal layer 12 are brought into the planar state or the focal conic state, and thus, a display is produced. The plurality of scan electrodes and the plurality of data electrodes are formed in the upper side electrode layer 14 and the lower side electrode layer 15.

The panel configuration of the cholesteric liquid crystal display element is widely known, and therefore, more explanation is omitted.

In the embodiment, the common driver 28 and the segment driver 29 are realized by a general-purpose STN driver.

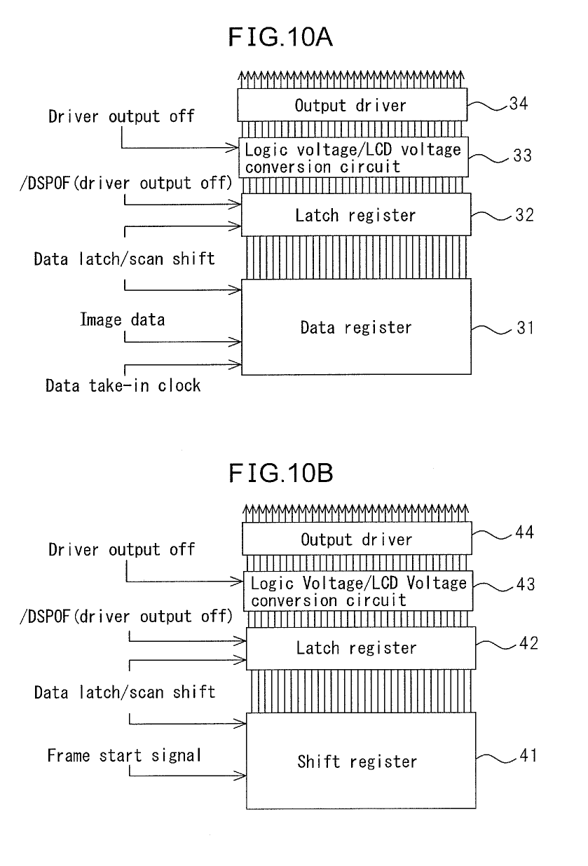

FIG. 10A illustrates a configuration of the segment driver 29 and FIG. 10B illustrates a configuration of the common driver 28.

The segment driver 29 includes a data register 31, a latch register 32, a logic voltage/LCD voltage conversion circuit 33, and an output driver 34. The data register 31 takes in image data in response to the data take-in clock and shifts the step one by one. The latch register 32 latches data corresponding to one line taken in by the data register 31 in response to the data latch/scan shift signal. The data register 31 and the latch register 32 have a buffer for two lines, and therefore, it is possible to store the data of the next line in the data register 31 while the data of voltage of the latch register 32 is output. The logic voltage/LCD voltage conversion circuit 33 generates a voltage to be applied to each data line in accordance with the image data of each data line output from the latch register 32. The output driver 34 outputs the voltage output from the logic voltage/LCD voltage conversion circuit 33 to each data line. Consequently, the data register 31, the latch register 32, the logic voltage/LCD voltage conversion circuit 33, and the output driver 34 respectively have outputs in the number of data electrodes, i.e., 768 outputs in the first embodiment.

The common driver 28 includes a shift register 41, a latch register 42, a logic voltage/LCD voltage conversion circuit 43, and an output driver 44. The common driver 28 differs from the segment driver 29 in that the shift register 41 is provided in place of the data register 31 and in that the number of outputs is the number of scan electrodes, i.e., 1,024 in the embodiment. Consequently, the shift register 41, the latch register 42, the voltage data/LCD voltage conversion circuit 43, and the output driver 44 have 1,024 outputs, respectively. The shift register 41 resets the inside in response to the frame start signal, takes in line selection data in response to the data latch signal, and shifts the step one by one. The latch register 42 latches the output of the shift register 41 in response to the data latch signal.

As explained with reference to FIG. 6, in the dynamic drive system, the preparation period, the selection period, the evolution period, and the non-select period are provided and to each of the periods, four kinds of voltages are applied and the voltage has positive polarity and negative polarity, and therefore, the number of kinds of voltages is doubled and as a result, eight kinds of voltages in total are used. A high voltage is used to drive the cholesteric liquid crystal, however, a driver outputting eight kinds of high voltages is not commercialized yet at present and even if commercialized, the circuit scale thereof will be large, and therefore, the cost is raised accordingly.

In the embodiment, the common driver and the segment driver are realized by a commercialized general-purpose driver outputting six kinds (values) of outputs. For example, a driver is commercialized, which may be used both as a common driver and as a segment driver by switching the operating modes and this may be used to realize the common driver and the segment driver.

Consequently, the common driver and the segment driver have six kinds of power source input terminals to which six kinds of power source voltages are supplied. The number of power source input terminals for one voltage is not limited to one and may be two or more in some cases. Each of the drivers has a ground GND terminal and outputs GND (0 V). In other words, the common driver outputs six values+GND and the segment driver outputs six values+GND.

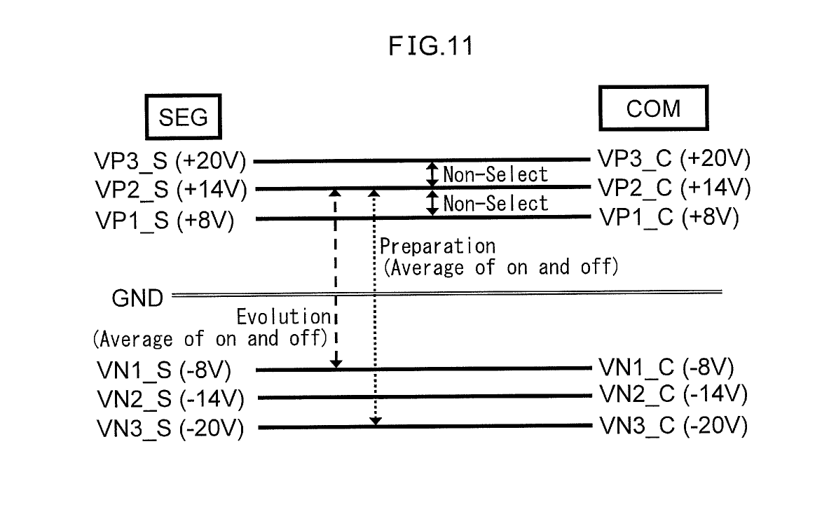

FIG. 11 is a diagram illustrating an general example of a power source voltage to be applied to a segment driver (SEG) and a common driver (COM) in a cholesteric liquid crystal display device using the simple matrix system.

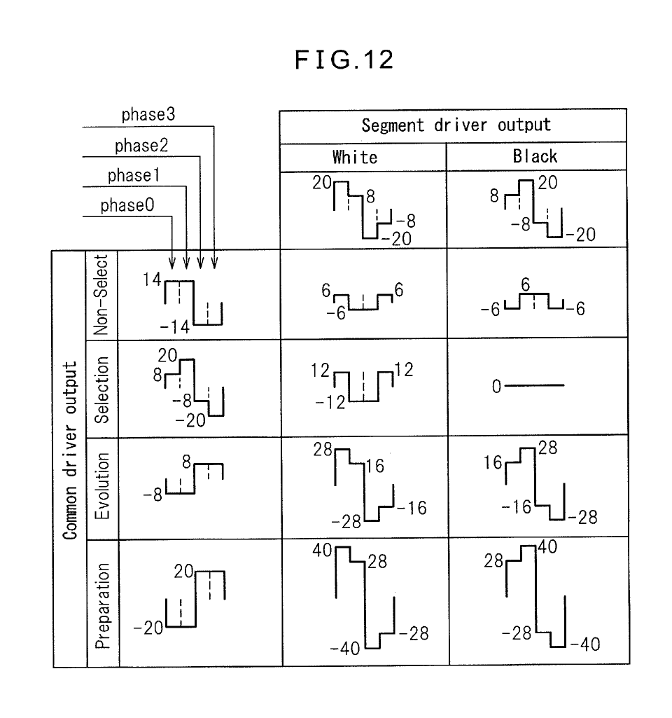

FIG. 12 is a diagram illustrating voltage waveforms the segment driver (SEG) outputs during the preparation, selection, evolution, and non-select periods, voltage waveforms the common driver (COM) outputs in accordance with the white and black displays, and voltage waveforms applied to the liquid crystal.

As illustrated in FIG. 12, one pulse is divided into a positive period and a negative period and the positive and negative periods are further divided into two phases. Consequently, one pulse has four phases.

The common driver 28 outputs the voltages during the preparation, evolution selection, and non-select periods without depending on image data. For example, the common driver 28 outputs a drive waveform that changes to +14 V, +14 V, −14 V, and −14 V in four cycles during the non-select period and outputs a drive waveform that changes to +8 V, +20 V, −9 V, and −20 V in four cycles during the selection period. Further, the common driver 28 outputs a drive waveform that changes to −8 V, −8 V, +8 V, and +8 V in four cycles during the evolution period and outputs a drive waveform that changes to −20 V, −20 V, +20 V, and +20 V in four cycles during the preparation period.

The segment driver 29 outputs ON/OFF during the selection period corresponding to the white and black displays of the image data in units of lines. For example, the segment driver 29 outputs a drive waveform that changes to +20 V, +8 v, −20 V, and −8 V in four cycles in the case of the white display and outputs a drive waveform that changes to +8 V, +20 V, −8 V, and −20 V in four cycles in the case of the black display. Consequently, the segment driver 29 does not output +14 V or −14 V. In this manner, eight kinds of voltage waveforms as illustrated in FIG. 12 are applied in accordance with the state of each pixel. That is, as illustrated in FIG. 11, the voltage of the positive pulse during the evolution period is a difference voltage between −8 V the common driver 28 outputs and +14 V, which is the average value of +20 V and +8 V the segment driver 29 outputs. The voltage of the negative pulse, the polarity of which being reversed, is a difference voltage between +8 V the common driver 28 outputs and −14 V, which is the average value of −20 V and −8 V the segment driver 29 outputs. The voltage of the positive pulse during the preparation period is a difference voltage between −20 V the common driver 28 outputs and +14 V, which is the average value of +20 V and +8 V the segment driver 29 outputs. The voltage of the negative pulse, the polarity of which being reversed, is a difference voltage between +20 V the common driver 28 outputs and −14 V, which is the average value of −20 V and −8 V the segment driver 29 outputs. The voltage of the positive pulse during the non-selection period is a difference voltage between +14 V the common driver 28 outputs and +20 V and +8 V the segment driver 29 outputs. The voltage of the negative pulse is a difference voltage between −14 V the common driver 28 outputs and −20 V and −8 V the segment driver 29 outputs.

The waveforms of the white display and the black display during the evolution period are combinations of waveforms of ±28 V and ±16 V in two phases and approximate a pulse of ±22 V, which are the average values. The waveforms of the white display and the black display during the preparation period are combinations of waveforms of ±40 V and ±28 V and approximate a pulse of ±34 V, which are the average values. Similarly, the waveform of the white display during the selection period approximates a pulse of ±12 V and the waveform during the non-selection period approximates a pulse of ±6 V. The waveform of the black display during the selection period is a pulse of 0 V in all the four phases.

As described previously, the drive voltage of the cholesteric liquid crystal has temperature dependence and it is desirable to perform temperature compensation of the drive voltage when driving the cholesteric liquid crystal by the dynamic drive system. As a result of the investigation of the temperature characteristics of the cholesteric liquid crystal currently used, great temperature dependence has been found in the drive voltage during the evolution period among the drive voltages during the respective periods.

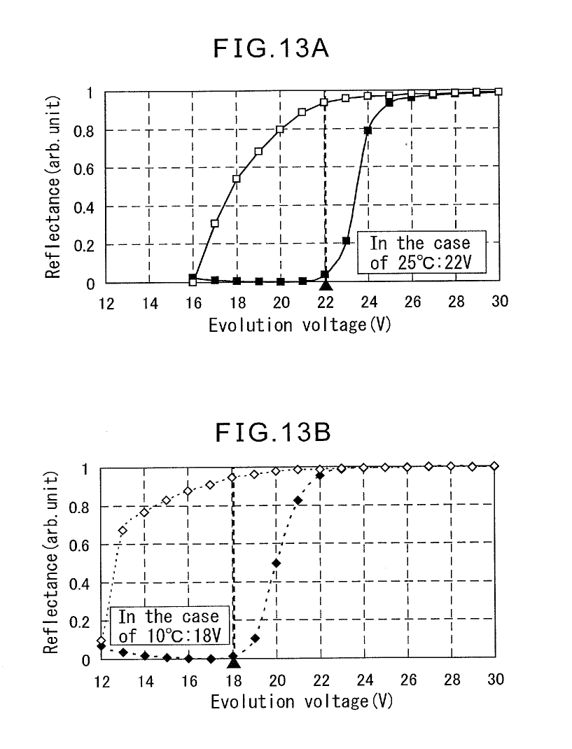

FIG. 13A and FIG. 13B are diagrams illustrating the temperature dependence of the drive voltage during the evolution period. FIG. 13A is a diagram illustrating the change characteristics of the reflectance of the display element for the drive voltage during the evolution period with the maximum reflectance being normalized to 1 in the case of 25° C. and FIG. 13B illustrates that in the case of 10° C. The drive voltages during the periods other than the evolution period are the same as above.

From the temperature characteristics of FIG. 13A and FIG. 13B, it is known that the optimum drive voltage during the evolution period is 22 V at 25° C., however, 18 V at 10° C., and there is a tendency for the voltage to shift toward the side of lower voltages as the temperature drops. This corresponds to the fact that the response of liquid crystal becomes slow as the temperature drops and indicates that it is desirable to change the drive voltage during the evolution period to an optimum value in accordance with temperature.

In the first embodiment, the drive voltage during the evolution period is changed in accordance with temperature. As described above, in the first embodiment, a plurality of power source voltages illustrated in FIG. 11 and FIG. 12 is supplied to the common driver 28 and the segment driver 29. The common driver 28 and the segment driver 29 generate the drive waveforms during each period by selectively outputting the supplied plurality of voltages. In order to change the drive voltage during the evolution period, the voltages supplied to the common driver 28 and the segment driver 29 are changed and in such a case, the drive voltages during other periods are also changed.

By supplying the plurality of power source voltages illustrated in FIG. 11 and FIG. 12 to the common driver 28 and the segment driver 29, the driver voltage during the evolution period becomes 22 V, which is an optimum value in the case of 25° C. The optimum drive voltage at 10° C. is 18 V and such a drive voltage may be generated as follows.

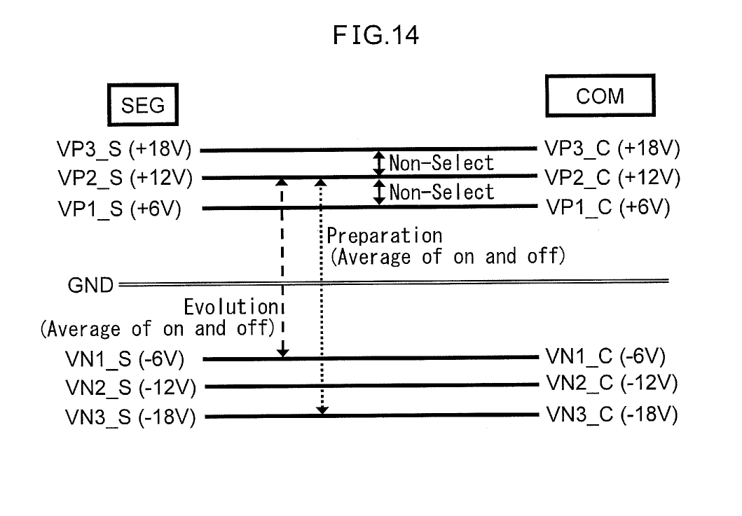

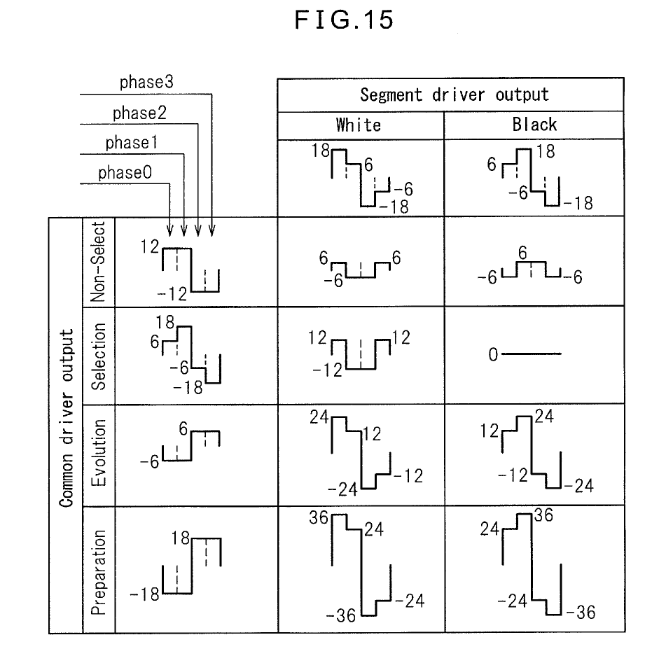

FIG. 14 is a diagram illustrating voltages to be supplied to the common driver 28 and the segment driver 29 to set the drive voltage during the evolution period to 18 V. FIG. 15 is a diagram illustrating voltage waveforms the segment driver (SEG) outputs during the preparation, selection, evolution, and non-select periods, voltage waveforms the common driver (COM) outputs in accordance with the white and black displays, and voltage waveforms applied to the liquid crystal when voltages in FIG. 14 are supplied.

In this case, the drive voltage during the evolution period is ±18 V, the average of ±24 V and ±12 V, however, the drive voltage during the preparation period at this time is ±30 V, the average value of ±36 V and ±24 V, and therefore, the drive voltage is reduced together with the drive voltage during the evolution period. The preparation period is the initialization phase in which the cholesteric liquid crystal is brought into the homeotropic state in the dynamic drive system and requires a high voltage of about 32 V or more. Because of that, by this method in which the drive voltage during the preparation period is reduced together with the drive voltage during the evolution period, when the drive voltage during the evolution period drops to 18 V, the drive voltage during the preparation period becomes insufficient and the dynamic drive is not maintained any longer. In this case, even if the drive voltage during the selection period is changed in whichever way, the reflectance of the display element does not increase and a deep-black display is produced.

In the embodiment, the voltages to be applied to the common driver 28 and the segment driver 29 are changed so as to change the drive voltage during the evolution period in accordance with temperature. As a result of this, the drive voltages during other periods change and when the drive voltage during the preparation period drops below a predetermined value at a low temperature and becomes insufficient, the common driver 28 increases the number of selected voltages when voltages to be output are selected from among the supplied voltages. In other words, the common driver 28 has six kinds of power source supply terminals and the GND terminal and to the six kinds of power source supply terminals, six kinds voltages, i.e., VP3_C, VP2_C, VP1_C, VN3_C, VN2_C, and VN1_C, are supplied and if the temperature is not low, the common driver 28 selects and outputs any one from among the six kinds of voltages. In contrast to this, when the temperature is low, the common driver 28 adds a selection destination so that GND is also output in addition to the six kinds of voltages VP3_C, VP2_C, VP1_C, VN3_C, VN2_C, and VN1_C supplied to the six kinds of power source supply terminals.

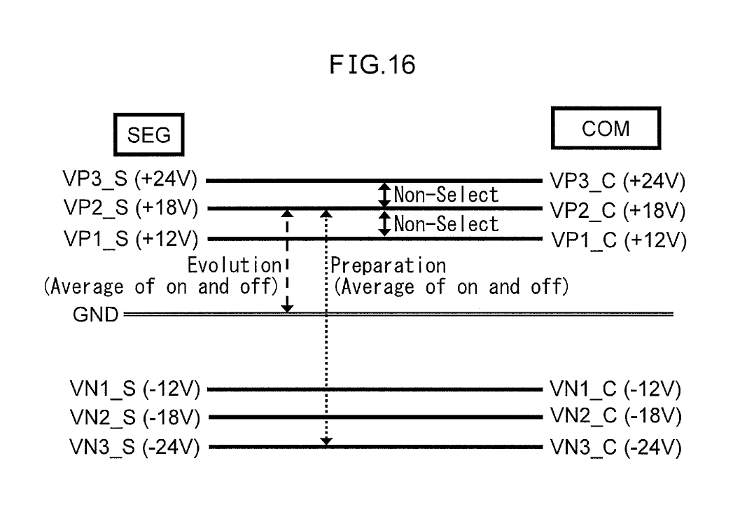

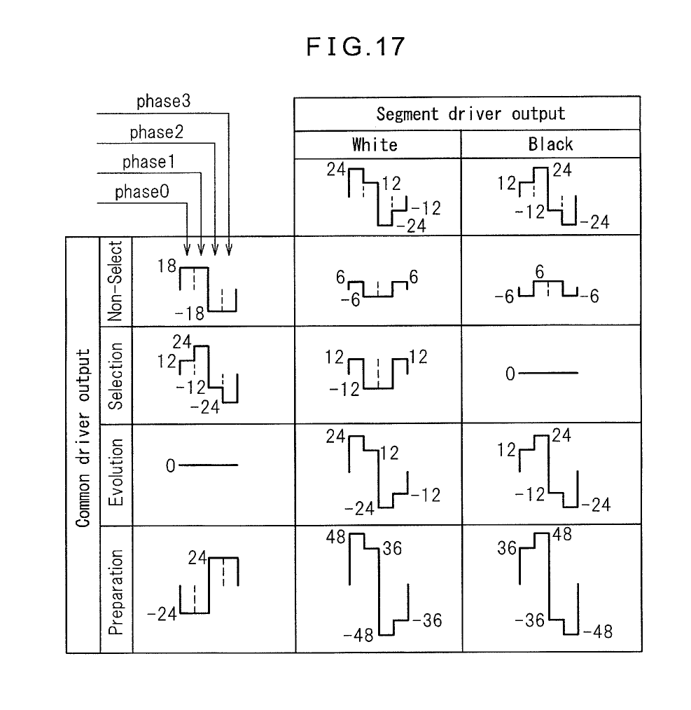

FIG. 16 is a diagram illustrating examples of voltages to be supplied to the common driver 28 and the segment driver 29 when the temperature is low. FIG. 17 is a diagram illustrating voltage waveforms the segment driver (SEG) 29 and the common driver (COM) output and voltage waveforms to be applied to the liquid crystal when the temperature is low.

As described previously, in the embodiment, the power sources of ±20 V, ±14 V, and ±8 V are supplied to the common driver 28 and the segment driver 29 as illustrated in FIG. 11 at an ordinary temperature. In contrast to this, the power sources of ±24 V, ±18 V, and ±12 V are supplied to the common driver 28 and the segment driver 29 as illustrated in FIG. 16 at a low temperature. Then, at a low temperature, the common driver 28 and the segment driver 29 output the voltage waveforms as illustrated in FIG. 17 during the preparation, evolution, selection, and non-select periods. When compared to FIG. 12 at an ordinary temperature, the voltage waveforms of the common driver 28 and the voltage waveforms of the segment driver 29 during the preparation, selection, and non-select periods at a low temperature are the same as those at an ordinary temperature, except in that the voltage values are different in correspondence to that the supplied voltages are different. On the other hand, the difference lies in that the common driver 28 outputs the voltage waveforms of ±8V at an ordinary temperature while outputs GND (0 V) in four phase at a low temperature during the evolution period. In other words, the common driver 28 outputs a voltage selected from among the six kinds of voltages supplied to the power source supply terminals at an ordinary temperature while outputs a voltage selected from among the six kinds of voltages and GND (0 V) at a low temperature.

Consequently, during the evolution period at a low temperature, a pulse of ±18 V is applied to the liquid crystal, which is the difference voltage between 0 V the common driver 28 outputs and ±18 V, which is the average value of ±24 V and ±12 V the segment driver 29 outputs. Further, during the preparation period at a low temperature, a pulse of ±42 V is applied substantially to the liquid crystal, during the non-select period, a pulse of ±6 V is substantially applied, and during the selection period, a pulse of ±12 V or 0 V is substantially applied. That is, the drive voltages during the non-select period and the selection period are the same as those at an ordinary temperature.

As described above, in the embodiment, during the evolution period at a low temperature, an optimum pulse of ±18 V is applied to the liquid crystal and at the same time, during the preparation period, a pulse of ±42 V is applied to the liquid crystal, and therefore, shortage of voltage does not occur and an excellent display may be produced.

FIG. 18 is a diagram illustrating the reflectance characteristics at a low temperature of 10° C. of the cholesteric liquid crystal display device of the embodiment, wherein the horizontal axis represents the drive voltage during the selection period and the vertical axis represents the reflectance. Even when the temperature is low, the reflectance changes by changing the drive voltage during the selection period and the reflectance is about 3% at 0 V for the black display and about 35% at 12 V for the white display. Consequently, it is possible to produce an excellent display.

As above, the fundamental principles to change the power source voltages to be supplied to the common driver 28 and the segment driver 29 and the drive voltages the common driver 28 and the segment driver 29 output in the embodiment are explained. Next, the control operation in the driver control circuit 27 to perform such an operation is explained.

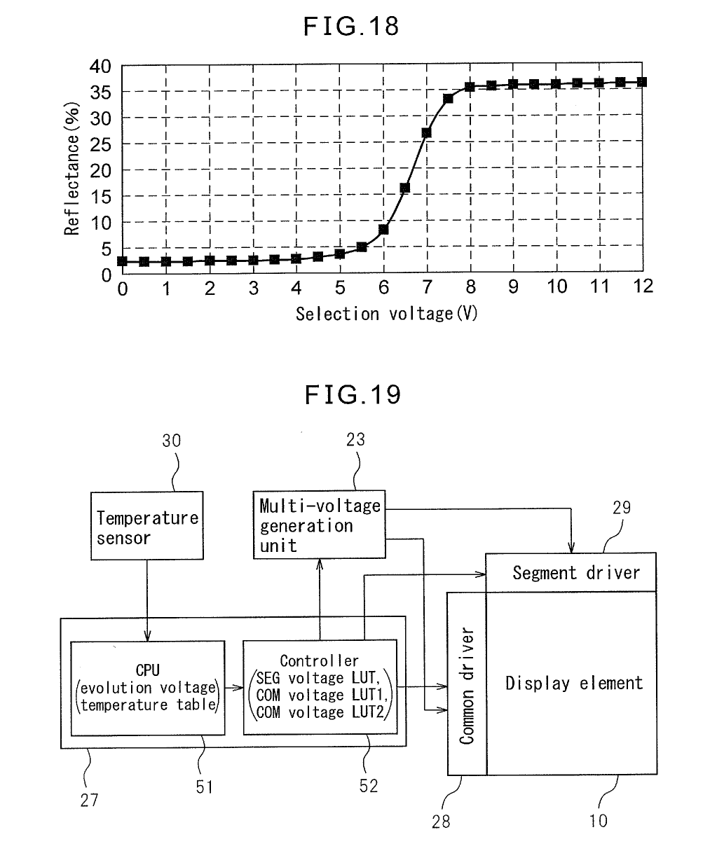

FIG. 19 is a diagram illustrating the internal configuration of the driver control circuit 27 and related parts. As illustrated in FIG. 19, the driver control circuit 27 has a CPU 51 and a controller 52. The CPU 51 has an evolution voltage temperature table. The controller 52 has a segment voltage lookup table (SEG voltage LUT), a first common voltage lookup table (COM voltage LUT1), and a second common voltage lookup table (COM voltage LUT2).

The multi-voltage generation unit 23 generates six kinds of voltages VP3, VP2, VP1, VN1, VN2, and VN3 and supplies the voltages to the common driver 28 and the segment driver 29. In the embodiment, the same voltage is supplied to the common driver 28 and the segment driver 29, however, it is also possible to supply different voltages.

The multi-voltage generation unit 23 changes the voltage values of the six kinds of voltages to be generated in response to the control signal of the driver control circuit 27 (the controller 52). The multi-voltage generation unit 23 generates a voltage having a predetermined voltage difference from a reference potential using, for example, a voltage follower circuit including an operational amplifier. The reference voltage is generated by converting digital data, which is the control signal from the controller 52, into an analog voltage by a D/A converter provided in the multi-voltage generation unit 23. The generation circuit of the plurality of voltages in the multi-voltage generation unit 23 is not limited to this and any circuit may be used as long as a plurality of desired voltages may generated in response to the control signal from the controller 52.

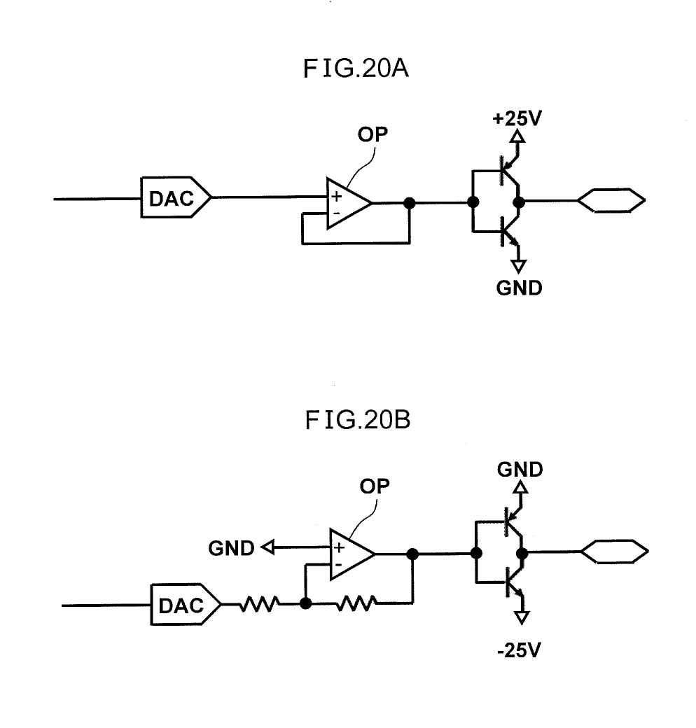

FIG. 20A and FIG. 20B are diagrams illustrating examples of a voltage generation circuit in the multi-voltage generation unit 23. FIG. 20A illustrates a positive voltage generation circuit and FIG. 20B illustrates a negative voltage generation circuit. The voltage setting value from the driver control circuit 27 is converted into an analog voltage by the D/A converter (DAC). A general DAC generates only a positive voltage, and therefore, a positive or negative voltage is generated using a voltage follower by an OP amplifier or an inversion amplifier circuit. After that, an electric current is amplified by a transistor, etc. By using the six positive voltage generation circuits in FIG. 20A, VP3_S, VP2_S, VP1_S, VP3_C, VP2_C, and VP1_C are generated and by using the six negative voltage generation circuits in FIG. 20B, VN3_S, VN2_S, VN1_S, VN3_C, VN2_C, and VN1_C are generated.

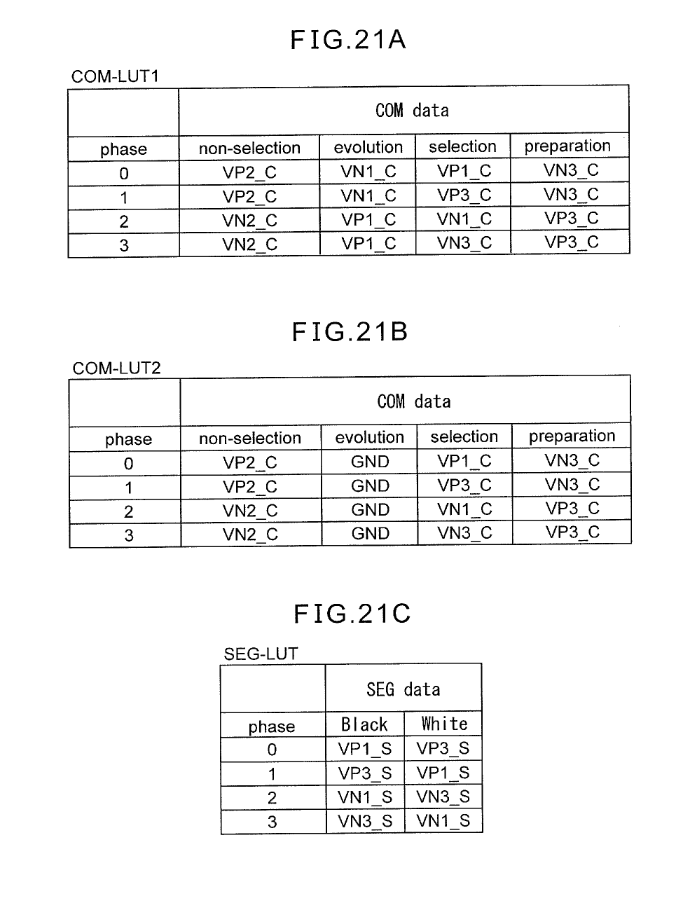

FIG. 21A illustrates the COM voltage LUT1, FIG. 21B illustrates the COM voltage LUT2, and FIG. 21C illustrates the SEG voltage LUT, respectively. The COM voltage LUT1 indicates which voltage of the voltages supplied to the power source supply terminal the common driver 28 outputs in the four phases during the preparation/evolution/selection/non-select periods under a first temperature condition including an ordinary temperature. For example, during the preparation period, the common driver 28 outputs VN3 in the phases 0 and 1, and VP3 in the phases 2 and 3. VN3_C means VN3 supplied to the common driver 28.

The COM voltage LUT2 indicates which voltage of the voltages supplied to the power source terminal the common driver 28 outputs in the four phases during the preparation/evolution/selection/non-select periods under a second temperature condition including a low temperature. The COM voltage LUT2 differs from the COM voltage LUT1 in that GND (0 V) is output in the phases 0 to 3 during the evolution period.

The SEG voltage LUT indicates which voltage of the voltages supplied to the power source supply terminal the segment driver 29 outputs to the pixels of the white display and the black display corresponding to one line during the selection period in the four phases at an ordinary temperature and a low temperature. VN3_S means VN3 supplied to the segment driver 29.

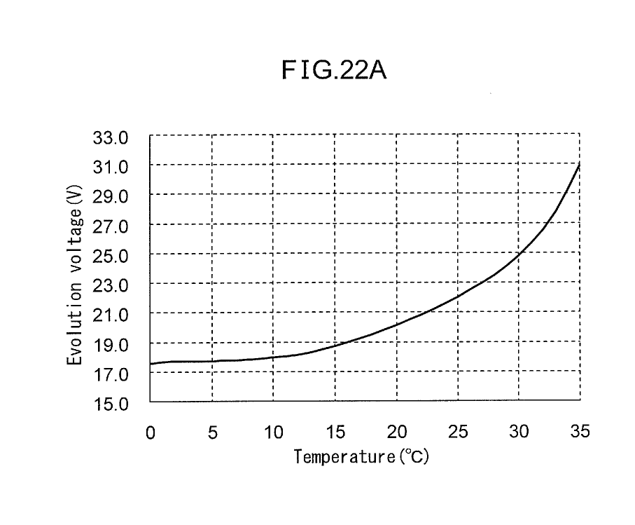

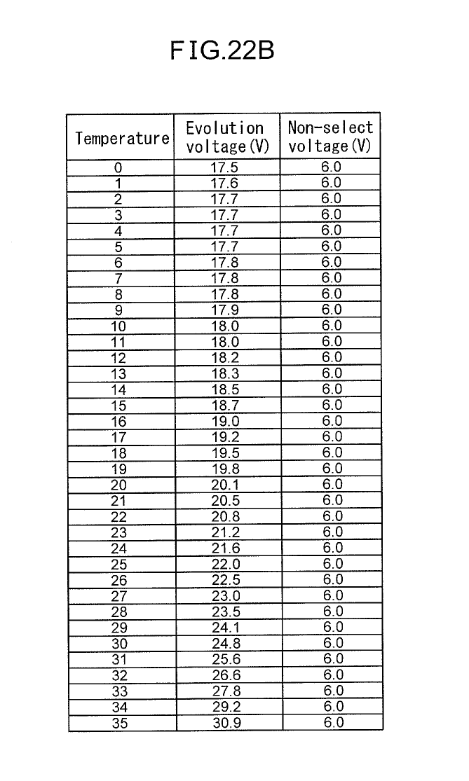

FIG. 22A and FIG. 22B are diagrams illustrating an evolution voltage temperature table. FIG. 22A is a graph illustrating the change in the optimum evolution voltage to the change in temperature and FIG. 22B illustrates a table storing the optimum evolution voltage and the non-select voltage at each temperature. The CPU 51 reads temperature from the temperature sensor 30 and determines the optimum evolution voltage and the non-select voltage based on the read temperature. Further, the CPU 51 determines which of the COM voltage LUT1 and the COM voltage LUT2 to use based on the determined evolution voltage and the non-select voltage, then, determines the six kinds of voltages VP3, VP2, VP1, VN1, VN2, and VN3, and transmits the result of the determination to the controller 52. The controller 52 generates a control signal to instruct to generate the determined VP3, VP2, VP1, VN1, VN2, and VN3 and outputs the control signal to the multi-voltage generation unit 23. In response to this, the multi-voltage generation unit 23 generates the specified VP3, VP2, VP1, VN1, VN2, and VN3 and supplies the voltages to the common driver 28 and the segment driver 29. The controller 52 controls the common driver 28 and the segment driver 29 based on one of the COM voltage LUT1 and the COM voltage LUT1 determined to use and the SEG voltage LUT and produces a display on the display element 10.

Next, the processing to determine which of the COM voltage LUT1 and the COM voltage LUT2 to use based on the evolution voltage and the non-select voltage determined in CPU 51, the processing to determine the six kinds of voltages VP3, VP2, VP1, VN1, VN2, and VN3, and the drawing processing are explained.

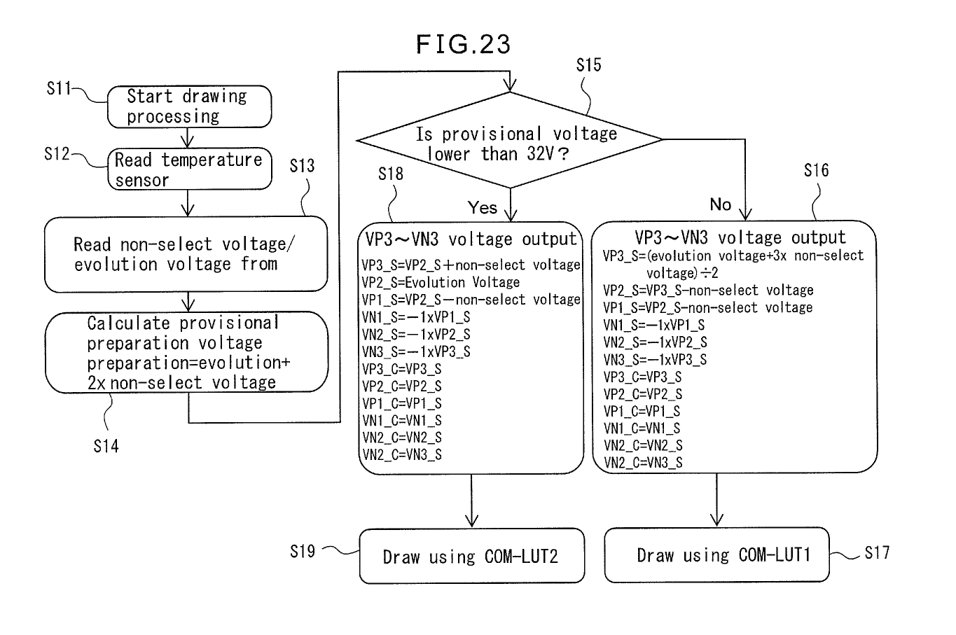

FIG. 23 is a diagram illustrating a processing flow of the above-mentioned processing.

In step S11, the drawing operation is stated.

In step S12, the CPU 51 reads temperature from the temperature sensor 30.

In step S13, the CPU 51 determines the evolution voltage and the non-select voltage from the read temperature based on the evolution voltage temperature table. For example, as illustrated in FIG. 22B, when the temperature is 25° C., the evolution voltage is determined to be 22.0 V (evolution voltage=22.0 V) and the non-select voltage to be 6.0 V (non-select voltage=6.0 V). Further, when the temperature is 10° C., the evolution voltage is determined to be 18.0 V (evolution voltage=18.0 V) and the non-select voltage to be 6.0 V (non-select voltage=6.0 V).

In step S14, the CPU 51 calculates the provisional preparation voltage by an equation of provisional preparation voltage=evolution voltage+2×non-select voltage.

In step S15, the CPU 51 determines whether the provisional preparation voltage is lower than the threshold value of 32 V. The threshold value is determined by a limit value to which a margin to a certain extent is added, the preparation voltage lower than which does not produce a display, resulting in the black display of the entire screen. When the provisional preparation voltage is lower than the threshold value of 32 V, the procedure proceeds to step S18, or to step S16 in other cases. When the provisional preparation voltage becomes lower than the threshold value of 32 V is when the temperature is low.

In step S16, the CPU 51 determines to use the COM voltage LUT1, calculates VP3, VP2, VP1, VN1, VN2, and VN3 in accordance with equations below, and transmits the information thereof to the controller 52. The controller 52 outputs a control signal to the multi-voltage generation unit 23 based on the information and the multi-voltage generation unit 23 generates VP3, VP2, VP1, VN1, VN2, and VN3.

VP3, VP2, VP1, VN1, VN2, and VN3 are calculated from the determined evolution voltage and the non-select voltage in accordance with calculation equations below.

VP3_S=(evolution voltage+3×non-select voltage)/2

VP2_S=VP3_S—non-select voltage

VP1_S=VP2_S—non-select voltage

VN1_S=−1×VP1_S

VN2_S=−1×VP2_S

VN3_S=−1×VP3_S

VP3_C=VP3_S

VP2_C=VP2_S

VP1_C=VP1_S

VN1_C=VN1_S

VN2_C=VN2_S

VN3_C=VN3_S

In step S17, the controller 52 controls the common driver 28 and the segment driver 29 using the COM voltage LUT1 and the SEG voltage LUT and produces a display on the display element 10.

In step S18, the CPU 51 determines to use the COM voltage LUT2, calculates VP3, VP2, VP1, VN1, VN2, and VN3 in accordance with equations below, and transmits the information thereof to the controller 52. The controller 52 outputs a control signal to the multi-voltage generation unit 23 based on the information thereof and the multi-voltage generation unit 23 generates VP3, VP2, VP1, VN1, VN2, and VN3.

VP3, VP2, VP1, VN1, VN2, and VN3 are calculated from the determined evolution voltage and the non-select voltage in accordance with equations below.

VP3_S=VP2 S +non-select voltage

VP2_S=evolution voltage

VP1_S=VP2 S - non-select voltage

VN1_S=−1×VP1_S

VN2_S=−1×VP2_S

VN3_S=−1×VP3_S

VP3_C=VP3_S

VP2_C=VP2_S

VP1_C=VP1_S

VN1_C=VN1_S

VN2_C=VN2_S

VN3_C=VN3_S

In step S19, the controller 52 controls the common driver 28 and the segment driver 29 using the COM voltage LUT2 and the SEG voltage LUT and produces a display on the display element 10.

In the processing described above, the provisional preparation voltage is calculated and determined whether or not to be smaller than the threshold value and then, which of the COM voltage LUT1 and the COM voltage LUT3 is to use is determined. However, it is also possible to determine which of the COM voltage LUT1 and the COM voltage LUT2 to user in accordance with temperature. In this case, step S14 may be deleted. Further, it is also possible to provide in advance a table that stores VP3, VP2, VP1, VN1, VN2, and VN3 in correspondence to temperature and in such a case, steps S16 and S18 may further be deleted.

In the example described above, the non-select voltage is 6V and constant and there are such relationships that VP2=VP3−non-select voltage, VP1=VP2−non-select voltage, VN3=−VP3, VN2=VP3+non-select voltage, and VN1=VN2+non-select voltage. Consequently, if the multi-voltage generation unit 23 is provided with a circuit configured to generate VP3 in response to the control signal from the controller 52 and to generate VP2 and VP1 by subtracting the non-select voltage (6 V) and twice the non-select voltage (12 V) from VP3, respectively, only VP3 may be determined and specified. This is the same in the case of VN3, VN2, and VN1 and only VN3 may be determined and specified, and if VN3 may be generated from VP3, only VP3 may be determined and specified.

The threshold value of the provisional preparation voltage to determine which of the COM voltage LUT1 and the COM voltage LUT2 to use is determined in accordance with the panel and in the case of a stacked type color display element, it may also be possible to make the threshold values differ in each of the red, blue, and green panels.

As described above, according to the embodiment, it is possible to perform drawing in the dynamic drive system even at a low temperature, and therefore, it is possible to extend the temperature range of application.

All examples and conditional language provided herein are intended for pedagogical purposes of aiding the reader in understanding the invention and the concepts contributed by the inventor to furthering the art, and are to be construed as limitations to such specifically recited examples and conditions, nor does the organization of such examples in the specification relate to a illustrating of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A drive method of a display element including cholesteric liquid crystal, the method including:
a preparation period during which the cholesteric liquid crystal is brought into a homeotropic state;
a selection period during which a final state of the cholesteric liquid crystal is selected; and
an evolution period during which the cholesteric liquid crystal is made a transition to a state selected during the selection period, wherein
a voltage to be applied to the cholesteric liquid crystal during the evolution period is changed in accordance with temperature.

2. The drive method of a display element including cholesteric liquid crystal according 1, wherein
the application of a voltage to the cholesteric liquid crystal is performed by a segment driver and a common driver,
the common driver comprises N (positive integer) kinds of power source input terminals and a plurality of sets of output terminals and selectively outputs M (M: positive integer, M<N) kinds of voltages of N kinds of voltages supplied to the N kinds of power source input terminals from the plurality of sets of output terminals, thereby the N kinds of voltages change to cause the applied voltage to the cholesteric liquid crystal during the evolution period to change, and
the applied voltage to the cholesteric liquid crystal during the preparation period changes in accordance with the change in the applied voltage to the cholesteric liquid crystal during the evolution period.

3. The drive method of a display element including cholesteric liquid crystal according to claim 2, wherein
when the applied voltage to the cholesteric liquid crystal during the preparation period is lower than a predetermined value, the number M is increased so that the applied voltage to the cholesteric liquid crystal during the preparation period becomes higher than the predetermined value.

4. The drive method of a display element including cholesteric liquid crystal according to claim 3, wherein the voltage raised by the increase in the number M is the ground.

5. A cholesteric liquid crystal display device comprising:
a cholesteric liquid crystal display element;
a segment driver and a common driver that apply a voltage to the cholesteric liquid crystal;
a multi-voltage generation circuit configured to generate and supply a plurality of power source voltages to the segment driver and the common driver;
a temperature sensor; and
a control circuit configured to control the segment driver, the common driver, and the multi-voltage generation circuit, wherein
the control circuit:
controls the segment driver and the common driver to perform a dynamic drive sequence having a preparation period during which the cholesteric liquid crystal is brought into a homeotropic state, a selection period during which the final state of the cholesteric liquid crystal is selected, and an evolution period during which the cholesteric liquid crystal is made a transition to the state selected during the selection period; and
controls the applied voltage to the cholesteric liquid crystal during the evolution period to change in accordance with temperature.

6. The cholesteric liquid crystal display device according to claim 5, wherein
the common driver comprises N (positive integer) kinds of power source input terminals and a plurality of sets of output terminals and selectively outputs M (M: positive integer, M<N) kinds of voltages of N kinds of voltages supplied to the N kinds of power source input terminals from the plurality of sets of output terminals, thereby the N kinds of voltages change to cause the applied voltage to the cholesteric liquid crystal during the evolution period to change, and
the applied voltage to the cholesteric liquid crystal during the preparation period changes in accordance with the change in the applied voltage to the cholesteric liquid crystal during the evolution period.

7. The cholesteric liquid crystal display device according to claim 6, wherein
when the applied voltage to the cholesteric liquid crystal during the preparation period is lower than a predetermined value, the common driver controls to increase the number M so that the applied voltage to the cholesteric liquid crystal during the preparation period becomes higher than the predetermined value.

8. The cholesteric liquid crystal display device according to claim 7, wherein
the voltage raised by the increase in the number M is the ground.
